(19) United States
(12) Patent Application Publication
(10) Pub. No.: US 2015/0348674 A1
(43) Pub. Date: Dec. 3, 2015

(54) TRANSMISSION CABLE

(71) Applicant: Kabushiki Kaisha Toshiba, Tokyo (JP)

(72) Inventor: Yasuki Torigoshi, Tachikawa Tokyo (JP)

(21) Appl. No.: 14/570,951

(22) Filed: Dec. 15, 2014

Related U.S. Application Data
(60) Provisional application No. 62/003,669, filed on May 28, 2014.

(51) Int. Cl. H01B 7/02

(52) U.S. Cl. CPC H01B 7/02

(57) ABSTRACT

According to one embodiment, a transmission cable in one embodiment generally includes at least two cables. Each of the cables includes a central conductor including an axis and an outer circumference and an insulator covering the outer circumference of the central conductor, and including an insulation surface and grooves in the insulation surface.

### CROSS-REFERENCE TO RELATED APPLICATIONS

This application claims the benefit of U.S. Provisional Application No. 62/003,669, filed May 28, 2014, the entire contents of which are incorporated herein by reference.

### FIELD

Embodiments described herein relate generally to a transmission cable.

### BACKGROUND

In recent years, signals used in various electronic circuits have been increased in speed. A high-speed signal includes, for instance, many higher order frequency components. Therefore, transmission cables ready for high-frequency components are required to stably operate an electronic circuit that uses high-speed signals.

Generally, a transmission cable comprising cables, each holding air in their respective insulating members, may be enumerated as a common transmission cable ready for high-frequency components. Furthermore, a regular cable structure must be maintained to be ready for high-frequency components.

However, any common transmission cable ready for high-frequency components has the following problems. They are very expensive. Nevertheless, they can not maintain their respective regular cable structures because they tend to bend. Therefore, the realization of a new technology that solves these problems is desired.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a cross-sectional view indicating the structure of a common cable, which is used as a constituent of a transmission cable.

FIG. 2 is a view indicating the external appearance of a transmission cable that uses common cables, each having such a structure as illustrated in FIG. 1.

FIG. 3 is a cross-sectional view indicating the cross-sectional structure of a cable used as a constituent of a transmission cable of one embodiment.

FIG. 4 is a side view indicating one external configuration of the cable used as the constituent of the transmission cable of the same embodiment.

FIG. 5 is a side view indicating another external configuration of the cable used as the constituent of the transmission cable of the same embodiment.

FIG. 6 is a cross-sectional view indicating one structure of the transmission cable in the same embodiment.

FIG. 7 is a cross-sectional view indicating one implemented structure of the transmission cable in the same embodiment.

FIG. 8 is a graph indicating the difference in transmission loss between a transmission cable of the same embodiment and a common transmission cable.

FIG. 9 is a cross-sectional view indicating another structure of the cable used as the constituent of the transmission cable of the same embodiment.

FIG. 10 is a cross-sectional view indicating still another structure of the cable used as the constituent of the transmission cable of the same embodiment.

FIG. 11 is a side view indicating a modified example of the structure of the cable that is used as the constituent of the transmission cable of the same embodiment.

FIG. 12 is a perspective view indicating the configuration of a cable that is used as a constituent of a transmission cable in connection with the modified example.

FIG. 13 is a side view indicating the configuration of a transmission cable that is connected with the modified example.

FIG. 14 is a side view indicating a further modified example of the structure of the transmission cable of the same embodiment.

FIG. 15 is a perspective view indicating the configuration of a cable that is used as a constituent of a transmission cable in connection with the further modified example.

FIG. 16 is a side view indicating the configuration of a transmission cable that is connected with the further modified example.

### DETAILED DESCRIPTION

Various embodiments will be described hereinafter with reference to the accompanying drawings.

In general, according to one embodiment, a transmission cable in one embodiment generally includes at least two cables. Each of the cables includes a central conductor including an axis and an outer circumference and an insulator covering the outer circumference of the central conductor, and including an insulation surface and grooves in the insulation surface.

It should be noted that we hereinafter refer to a single cable as a cable whereas a cable unit including at least two cables as a transmission cable.

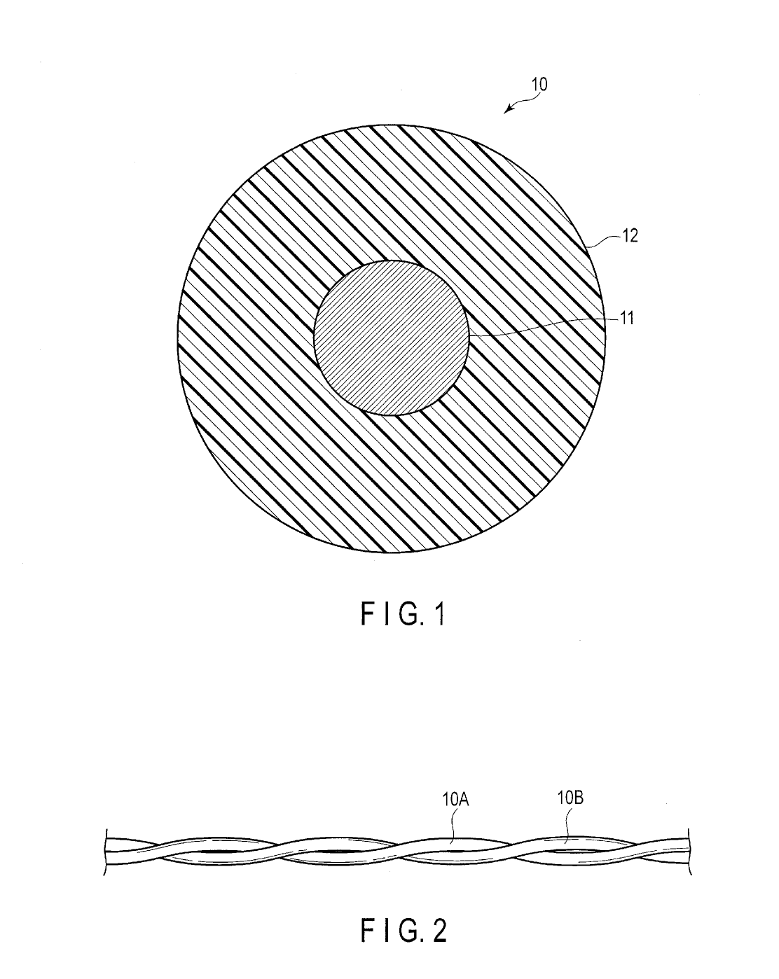

First of all, the structure of a common cable, which is used as a constituent of a transmission cable, will be explained with reference to FIG. 1.

FIG. 1 is a cross-sectional view indicating the structure of a common cable, which is used as a constituent of a transmission cable. As illustrated in FIG. 1, a cable 10 has a central conductor 11 and a dielectric (an insulator) 12 covering the outer circumference of the central conductor 11. The central conductor 11 is made of copper or silver or aluminum, for instance. The dielectric 12 is made of polyethylene, for instance. What is obtained by using a plurality of cables, each being the same cable as the cable 10, and twisting them as illustrated in FIG. 2 is a transmission cable (a differential transmission line). Note that it does not matter to a transmission cable if a plurality of cables are not twisted together as long as a plurality of cables are used (for instance, it does not matter if a plurality of cables are merely bundled up or put together).

Now, conditions necessary for achieving a high-speed signal (digital signal) transmission will be explained. A transmission cable must be ready for high frequencies to achieve high-speed signal transmission. In order to be ready for high frequencies the following two conditions must be satisfied: (a) the loss in physical properties must be reduced; and (b) the excessive reflection of a signal must be suppressed.

The conditions (a) and (b) will be explained below in detail.

The condition (a), the loss in physical properties, includes a conductor loss and a dielectric loss.

First, the conductor loss is a transmission loss caused by the characteristics of the conductor. More specifically, the conductor loss is a transmission loss that is largely affected by the physical size of the conductor, and will reduce with increase in the physical size of the conductor. When a cable is fixed in diameter (thickness), an effective dielectric constant ε between its conductor and its GND must be made small in order to increase the physical size of its conductor, or in order to reduce its conductor loss.

Second, the dielectric loss is a transmission loss that is in proportion to the square root of a frequency f, a dielectric loss tangent σ and an effective dielectric constant ε.

Dielectric loss ∝\sqrt{f×tan σ×ε} (1)

As described in the above expression (1), the dielectric loss depends on the effective dielectric constant ε or the dielectric loss tangent σ. To reduce the dielectric loss, the effective dielectric constant ε or the dielectric loss tangent σ must be made small, requiring use of a dielectric having a low dielectric constant or making the dielectric foam to introduce air, which has a lower dielectric constant than the dielectric.

As having been explained above, all that must be done to reduce the conductor loss and the dielectric loss is to reduce the effective dielectric constant ε or the dielectric loss tangent σ.

However, if a dielectric having a low dielectric constant is used or if the dielectric is made to foam to introduce air, which has a lower dielectric constant than the dielectric, to reduce the effective dielectric constant ε or the dielectric loss tangent σ, the cost will rise correspondingly, which is a problem.

In addition, in order to satisfy the condition (b), namely, in order to suppress the excessive reflection of a signal, the characteristic impedance of the transmission cable must be maintained, to which end the plurality of cables constituting the transmission cable must be always kept apart from each other at a constant distance between them.

However, since a common transmission cable, in which a plurality of common cables are twisted together as illustrated in FIG. 2, is substantially cylindrical, it tends to warp longitudinally, due to which it will be difficult to always keep the conductors of the cables apart from each other at a constant distance, which is a problem.

Therefore, the following measures are taken in order to satisfy the conditions (a) and (b) in the transmission cable of one embodiment.

Grooves (spaces) are provided in a dielectric, which is a constituent of a cable;

Each cable, a constituent of a transmission cable, is made to have a shape that causes it at its circumferential portion to easily engage with any adjacent cables when assembled.

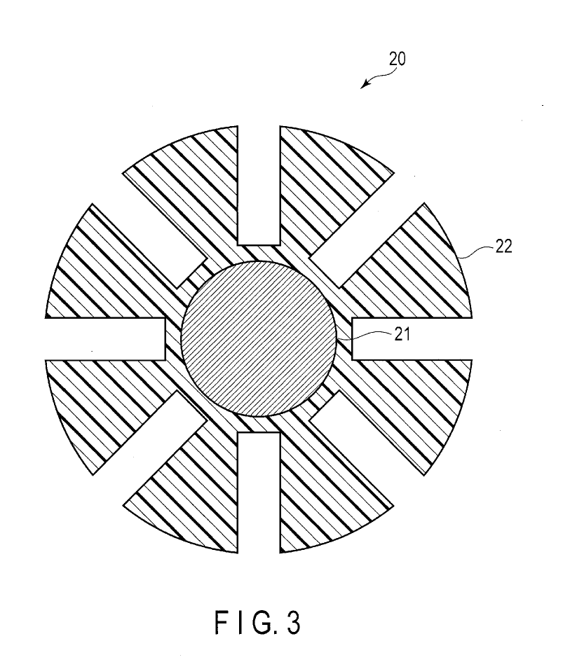

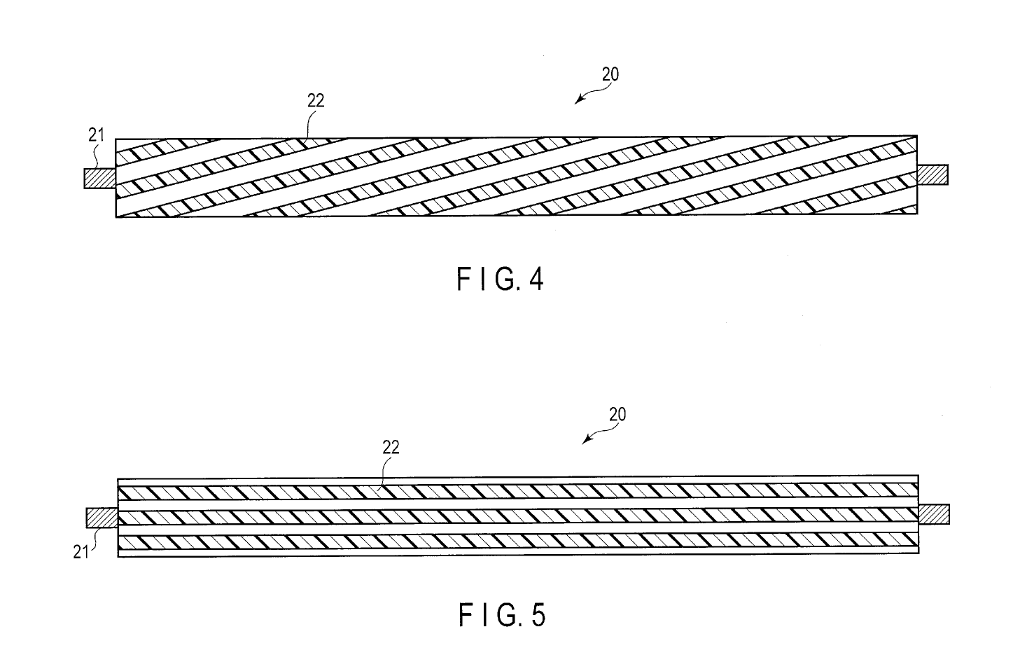

Now, a transmission cable in one embodiment will be explained below with reference to FIG. 3 and FIG. 4.

FIG. 3 is a cross-sectional view indicating the cross-sectional structure of a cable, which is a constituent of a transmission cable in one embodiment. FIG. 4 is a side view indicating the external configuration of the cable, which is the constituent of the transmission cable of the same embodiment. As illustrated in FIG. 3, a cable 20 has a central conductor 21 and a dielectric 22 covering the outer circumference of the central conductor 21. The dielectric 22 has grooves formed in the surface of the dielectric. FIG. 4 illustrates a case where the grooves spirally extend along the axis. Furthermore, as illustrated in FIG. 5, it is possible that the grooves may extend parallel to the axis. The provision of the grooves in the dielectric 22 makes it possible to replace a part of the dielectric 22 with air, which is lower than the dielectric 22 in dielectric constant, resulting in reduction in effective dielectric constant ε. Namely, the loss in physical properties will be reduced and thus the condition (a) will be satisfied.

It should be noted that the grooves running through the dielectric 22 may be formed when producing a cable by previously preparing a mold having protrusions corresponding to the grooves and pouring into the mold resin (polyethylene) to be the dielectric 22, or alternatively the grooves may be formed with a cutter or the like after the cable has been produced. The number of grooves and the size (length or depth) of each groove are optional in value, but it is preferable to replace as much of the dielectric 22 as possible with air, which has a low dielectric constant, to reduce the effective dielectric constant ε, so that it is desirable that the largest possible number of largest grooves possible be formed. For instance, when the grooves are spirally formed as illustrated in FIG. 4, it is desirable that the distance between any two adjacent grooves should be as short as possible. Similarly, when the grooves are formed to be parallel to the axis as illustrated in FIG. 5, it is also desirous that the distance between any two adjacent grooves should be as short as possible.

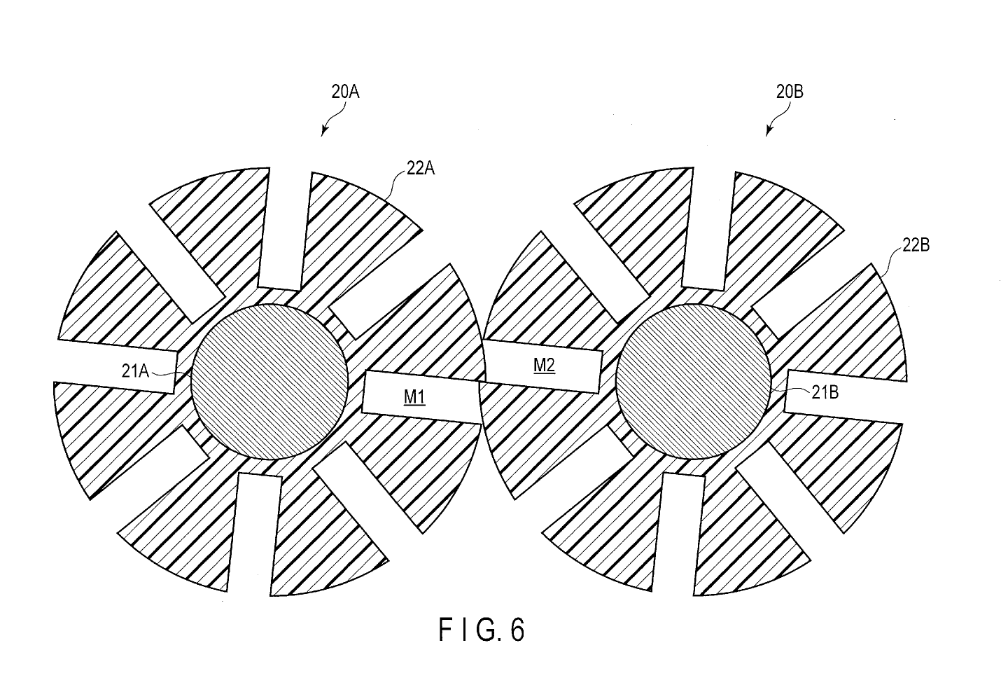

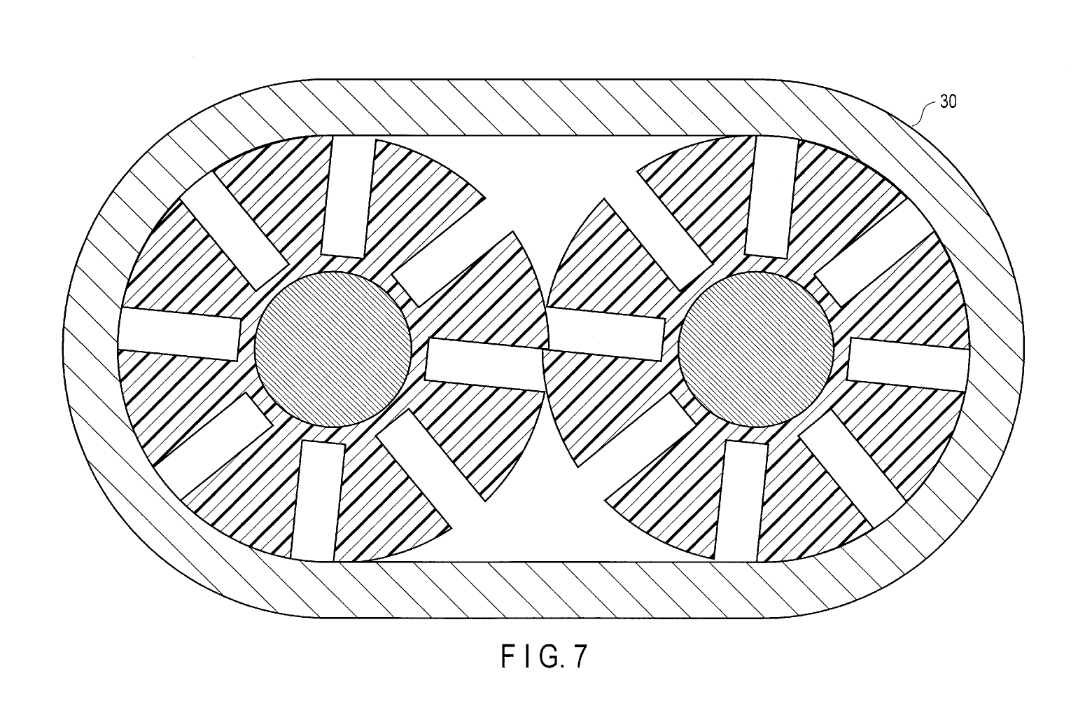

FIG. 6 is a cross-sectional view indicating the cross-sectional structure of a transmission cable in the same embodiment. FIG. 6 illustrates a transmission cable including two cables 20A and 20B, and having such a structure that one groove M1 of the grooves in cable 20A is caught on (engages with) one groove M2 of the grooves in cable 20B. The provision of the grooves in each of dielectrics 22A and 22B makes it possible not only to reduce the aforementioned effective dielectric constant ε but also to prevent the transmission cable from warping longitudinally even if the transmission cable is formed of twisted cables. Namely, the excessive reflection of a signal will be suppressed and thus the condition (b) will be satisfied. Incidentally, the grooves extending through each of dielectrics 22A and 22B as illustrated in FIG. 6 may have any one of the external configurations as illustrated in FIG. 4 and FIG. 5. When the transmission cables in the aforementioned embodiment are used in an electronic circuit or the like, the transmission cables are individually covered with a shield 30 (a braiding shield, an aluminum tape, etc., for instance) as illustrated in FIG. 7.

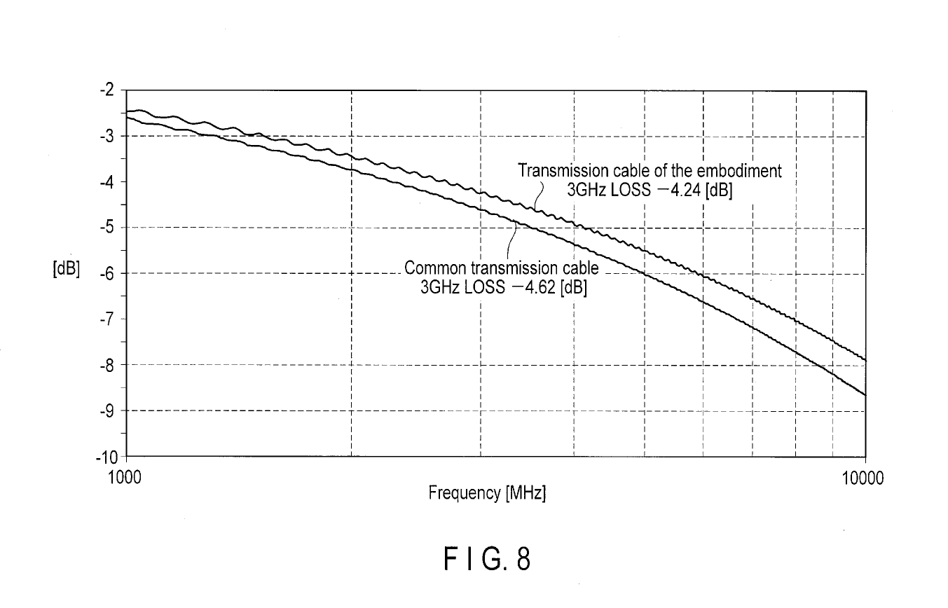

FIG. 8 is a graph indicating a difference in transmission loss in the case of a frequency of 3 GHz between a transmission cable of the same embodiment and a common transmission cable. FIG. 8 indicates that a transmission loss in the common transmission cable may be −4.62 [dB], whereas a transmission loss in the transmission cable in the same embodiment may be −4.24 [dB]. Therefore, reduction in transmission loss is achieved.

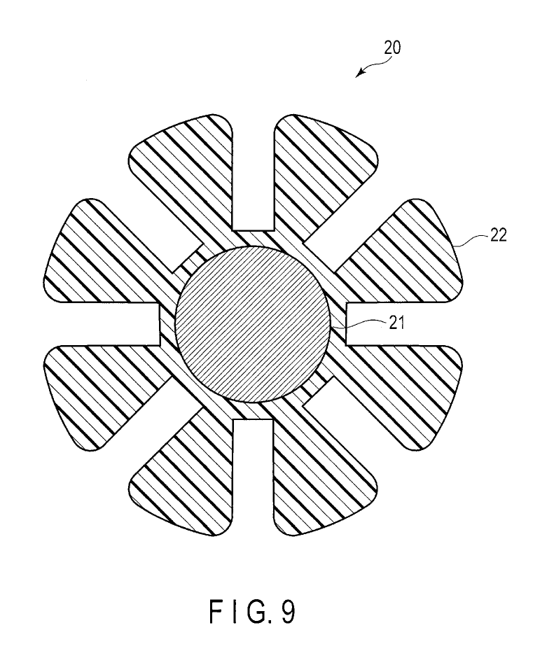

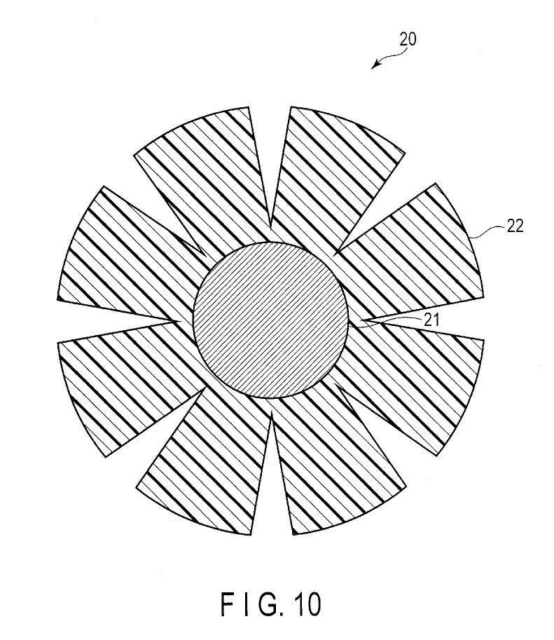

The grooves formed in the dielectric 22 are not limited to those individually having such a shape as illustrated in FIG. 3, but it is possible, for instance, that each groove has an opening portion whose edges are round as illustrated in FIG. 9. Furthermore, it is possible that the grooves formed in the dielectric 22 individually have a wedge shaped cross-section that becomes narrower in width as advancing to the center, as illustrated in FIG. 10, for instance. In short, it is desirable that a number of cables individually should have a shape that causes them to engage with each other at their respective circumferential portions when they are twisted together. The grooves formed in the dielectric 22 are simply a means of replacing a part of the dielectric 22 with air, which has a low dielectric constant, and preventing the transmission cable, which is made of the twisted cables, from warping longitudinally, so that any shape will do for the grooves so long as the grooves satisfy these two conditions.

The embodiment having been described above makes it possible to provide a transmission cable having a low physical property loss, is prevented from warping longitudinally, and is less expensive than common transmission cables merely by providing grooves in the dielectric, a constituent of the transmission cable.

### Modified Examples

Now, modified exemplary transmission cables of the aforementioned embodiment will be described.

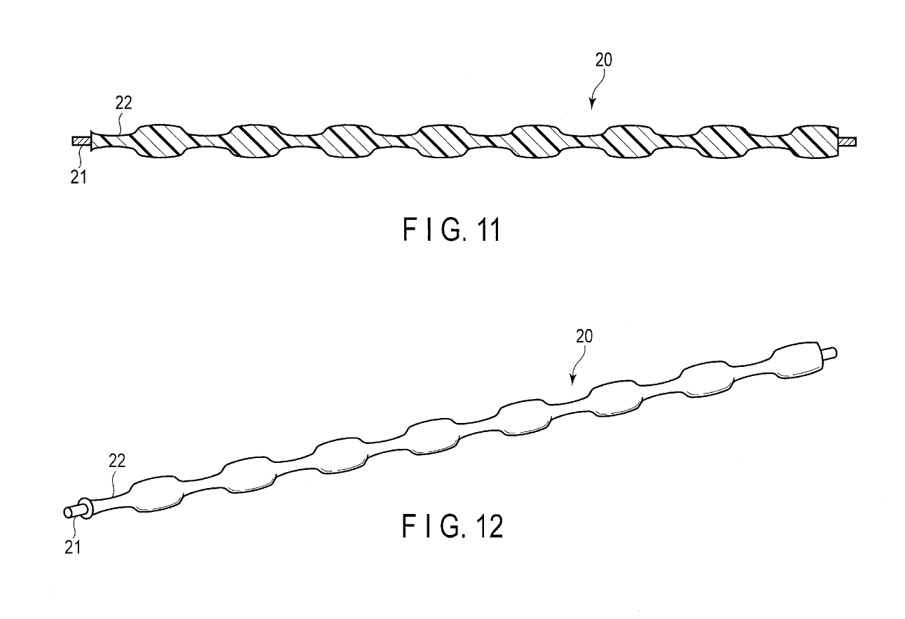

In the aforementioned one embodiment, a number of grooves, such as illustrated in FIG. 3, FIG. 9, or FIG. 10, are formed in the dielectric of each of the cables in order to satisfy the conditions (a) and (b). However, cables that satisfy the conditions (a) and (b) are not confined to the cables in the aforementioned embodiment, but a cable having a structure such as illustrated in FIG. 11 and FIG. 12 may be counted as a further cable that satisfies the conditions (a) and (b).

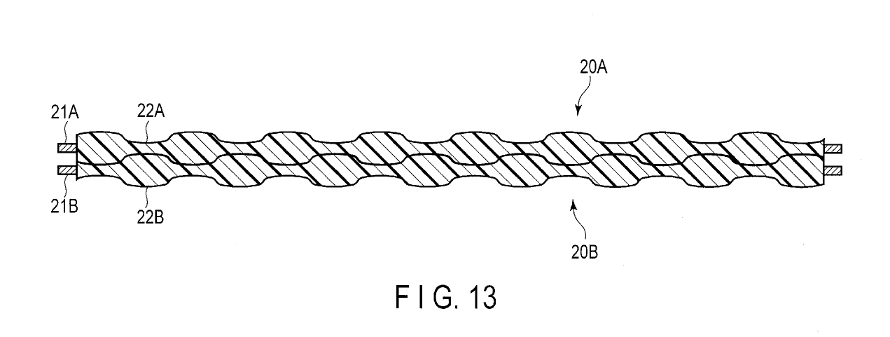

FIG. 11 is a side view of a modified exemplary cable that is used as a constituent of a modified exemplary transmission cable obtained by modifying the aforementioned transmission cable of the one embodiment. FIG. 12 is a perspective view illustrating the external appearance of the modified exemplary cable, a constituent of the modified exemplary transmission cable. In FIG. 11 and FIG. 12, the dielectric 22, or a constituent of the cable 20, has a series of protuberances (bulges in the circumferential surface defining ring-shaped grooves), which are provided one behind another along the axis so that the dielectric 22 will change in diameter along the axis in such a manner that minor diameter regions alternate with major diameter regions. This configuration also makes the dielectric 22 to have a plurality of spaces in its surface, each space defined by any adjacent two protuberances, and thus the configuration makes it possible to replace a part of the dielectric 22 with air, which has a low dielectric constant. In addition, when at least two cables, each being such a cable as illustrated in FIG. 11 or FIG. 12, are used to construct a transmission cable, they can engage with (get caught on) each other as illustrated in FIG. 13, and thus will prevent the transmission cable from bending longitudinally.

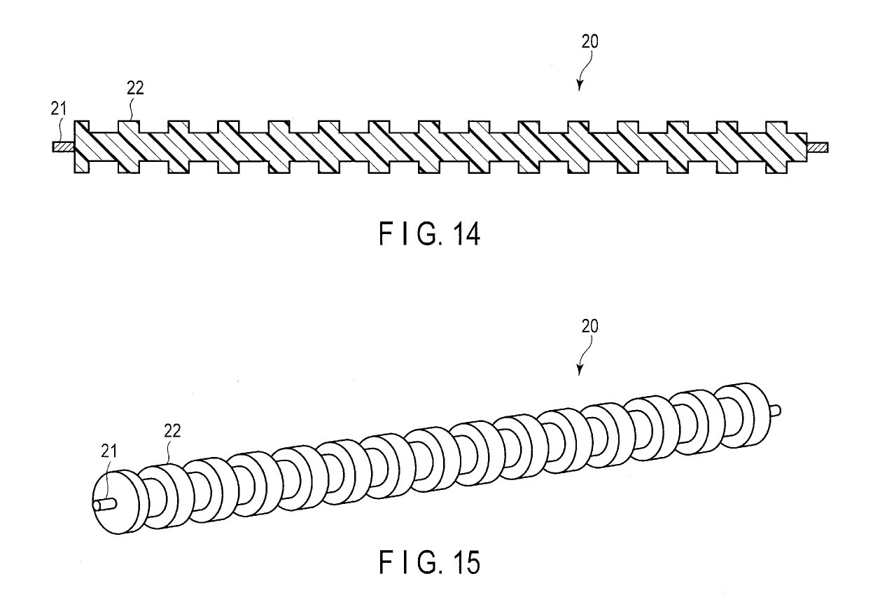

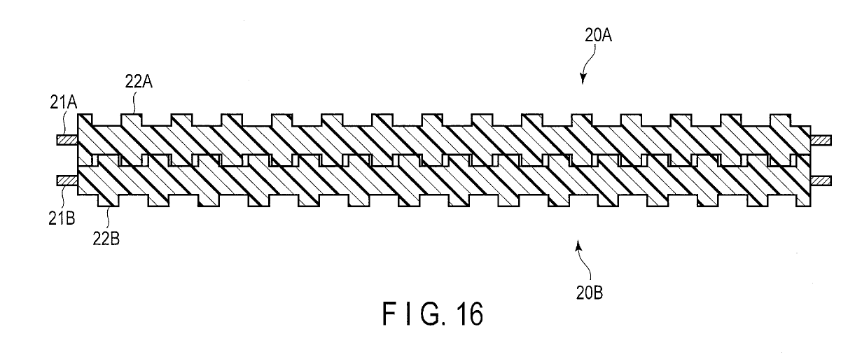

Similarly, an external appearance as illustrated in FIG. 14 or FIG. 15 may also be contrived. In FIG. 14 and FIG. 15, the dielectric 22, a constituent of the cable 20, has a series of depressions (grooves or a comb teeth portion), which are provided one behind another along the axis so that the dielectric 22 will change in diameter along the axis in such a manner that minor diameter regions alternate with major diameter regions. This configuration also makes the dielectric 22 to have a plurality of spaces in its surface, each space defined by any adjacent two of the depressions, and thus the configuration makes it possible to replace a part of the dielectric 22 with air, which has a low dielectric constant. In addition, when a transmission cable is constructed by at least two cables, each being such a cable as illustrated in FIG. 14 or FIG. 15, they can engage with (or get caught on) each other as illustrated in FIG. 16 and thus they will prevent the transmission cable from bending longitudinally.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A transmission cable comprising at least two cables, each of the cables comprising:
a central conductor comprising an axis and an outer circumference; and
an insulator covering the outer circumference of the central conductor, and comprising an insulation surface and grooves in the insulation surface.

2. The transmission cable of claim 1, wherein the grooves in the insulation surface spirally extend along the axis.

3. The transmission cable of claim 1, wherein the grooves in the insulation surface extend parallel to the axis.

4. The transmission cable of claim 1, wherein the grooves in the insulation surface make diameter of the insulator alternately change between large and small along the axis.

5. The transmission cable of claim 1, wherein each of the grooves in the insulation surface comprises an opening portion and two rounded opposite edges defining the opening portion.

6. The transmission cable of claim 1, wherein each of the grooves in the insulation surface has a wedge-shaped cross section.
